(19) United States
(12) Patent Application Publication
(10) Pub. No.: US 2012/0117974 A1
(43) Pub. Date: May 17, 2012

(54) AIR FLOW DELIVERY AND FUEL CONSUMPTION CONTROL FOR AIRCRAFT AIR MANAGEMENT AND AUXILIARY POWER SYSTEMS

(75) Inventors: Paul E. Hilgeman, Santee, CA (US); Anthony C. Jones, San Diego, CA (US); Martin A. Peplow, San Diego, CA (US)

(73) Assignee: HAMILTON SUNDSTRAND CORPORATION, Windsor Locks, CT (US)

(21) Appl. No.: 12/947,406

(22) Filed: Nov. 16, 2010

(51) Int. Cl. F02C 6/08; F02C 9/18

(52) U.S. Cl. 60/772; 60/785

(57) ABSTRACT

A turbine controller controls the operation of a gas turbine generator used to drive an electric generator of an aircraft. The turbine controller controls the gas turbine generator according to air flow demand signals indicative of air flow required by an air management system that regulates cabin pressure and temperature of the aircraft.

### BACKGROUND

The present invention relates generally to control systems for gas turbine engines. More particularly, the present invention relates to an auxiliary power unit (APU) control system and an air management system.

Air management systems are regulatory systems commonly used in modern aircraft to control temperature, pressure, and air flow in aircraft cabins, but may sometimes also control air flow to other non-engine aircraft components. It is common for the air used by the air management system to be bled off of one or more of the aircraft's gas turbine engines. In particular, air is often bled off of auxiliary power units so as not to burden the aircraft's main engines.

Whether from an APU or a main engine, a portion of the air intake of at least one engine compressor is usually diverted into the air management system, rather than being fed to a combustor. Driving the compressor of a gas turbine generator requires power, and the efficiency of a gas turbine generator is limited, in part, by the energy expended to compress input gas. Diverting input gas from the compressor means that the compressor is burdened by the need to compress some amount of gas beyond what is actually used to generate power. This burden reduces the efficiency of operation of the gas turbine engine as a whole.

The air demands of air management systems may vary with time. Air management systems are designed to draw a sufficient flow of compressor air to match these varying demands. In past systems, a fixed fraction of compressor air was usually diverted from an engine compressor, a variable portion of which was used by the air management system. Any excess or unneeded portion of this bleed air was dumped overboard. This practice was inefficient, since the compressor would frequently draw and compress unneeded air.

### SUMMARY

One embodiment of the present invention is a system that includes a gas turbine engine, an air management system, and a turbine controller. The gas turbine engine is capable of driving an electric generator. The air management system regulates cabin pressure and temperature in an aircraft, and is connected to receive bleed air from the gas turbine engine. The turbine controller controls operation of the gas turbine engine according to air flow demand signals indicative of air flow required by the air management system.

### BRIEF DESCRIPTION OF THE DRAWINGS

FIG. 1 is a block diagram of the system of the present invention.

FIG. 2 is a block diagram of the APU controller of the present invention.

FIG. 3 is a flow diagram illustrating the steps of the control method of the present invention.

FIG. 4 is a block diagram of an alternative embodiment of the system of the present invention.

### DETAILED DESCRIPTION

A gas turbine engine and a method for controlling that engine based on inputs from an air management system of an aircraft are provided. By controlling the orientation of compressor inlet guide vanes and driving the turbine at the minimum speed required to meet the demands of the air management system, the gas turbine engine can be run at lower power when less than maximum bleed air is required by the air management system. In this way, average system efficiency is improved.

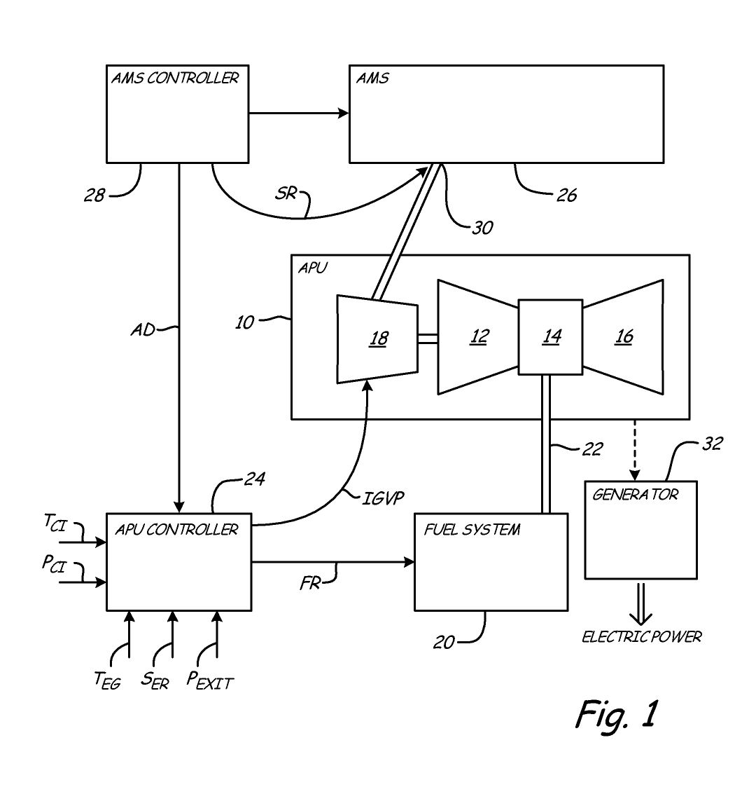

FIG. 1 is a diagram of a system of the present invention, including auxiliary power unit (APU) 10 (which is a gas turbine engine that includes primary compressor 12, combustor 14, turbine 16, and load compressor 18), fuel system 20 with fuel line 22, APU controller 24, air management system 26, air management system controller 28, siphon 30, and generator 32. Primary compressor 12 compresses atmospheric gas and feeds this compressed gas to combustor 14. Combustor 14 injects fuel into this compressed gas, and ignites it. Turbine 16 extracts energy from the resulting high-pressure, high-temperature gas in the form of turbine rotation. Load compressor 18 compresses air for use by air management system 26. During ordinary operation, turbine 16 drives both primary compressor 12 and load compressor 18, and combustor 14 receives fuel from fuel system 20 via fuel line 22. APU controller 24 controls the rate of fuel delivery from the fuel system, as well as other parameters. APU 10 drives generator 32, which converts mechanical energy into electric power. Generator 32 supplies electric power to various systems throughout the aircraft.

Air management system (AMS) 24 regulates cabin air pressure and temperature on the aircraft, and may include, for instance, cabin air conditioning systems. Air management system controller 28 controls the flow of air from load compressor 18 to air management system 26 via siphon 30. Air management system 26 may require varying amounts of airflow at different times. Air management system controller 28 determines the air flow required by air management system 26 at any particular time, and, using siphon regulation signal SR, accordingly controls the amount of air drawn from load compressor 18 by siphon 30. Air management system controller 28 also communicates the air flow required by air management system 26 to APU controller 24 via airflow demand signal AD. Airflow demand signal AD indicates the amount of bleed air to be drawn from load compressor 18 as a fraction of the maximum amount that load compressor 18 can provide.

APU controller 24 regulates the air intake of load compressor 18 and the fuel intake of combustor 14. In particular, APU controller 24 regulates compressor air intake by controlling the position of inlet guide vanes in load compressor 18 via compressor inlet guide vane position command IGVP, and regulates combustor fuel intake by controlling fuel system 20 via fuel flow rate command FR. Fuel system 20 may include a fuel supply with pumps, valves, or other components for metering fuel, but may otherwise take any form that is capable of delivering fuel at a commanded rate to APU 10. APU controller 24 will also receive additional inputs, including but not limited to compressor inlet temperature signal T_{CI}, compressor inlet pressure signal P_{CI}, exhaust gas temperature signal T_{EG}, engine rotational speed signal S_{ER}, and compressor exit pressure signal P_{EXIT}, which reflect corresponding engine parameters. In one embodiment these parameters are measured on the APU. In an alternative embodiment, some of these parameters may be measured elsewhere, or calculated from other measurements.

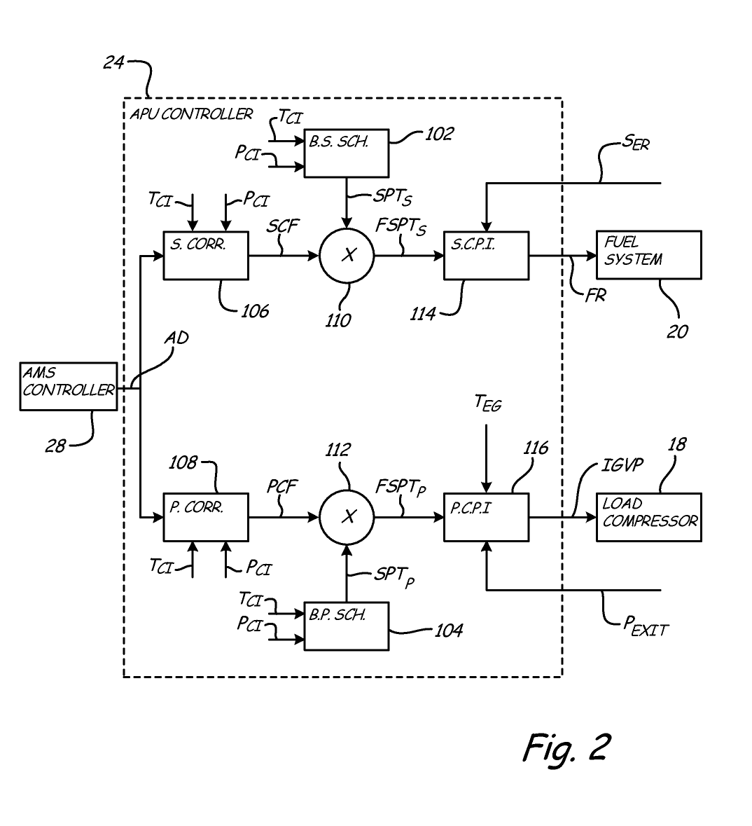

FIG. 2 is a functional block diagram of APU controller 24, including air management system controller 26, load compressor 18, fuel system 20, baseline speed schedule (B. S. SCH.) 102, baseline pressure schedule (B. P. SCH.) 104, speed correction block (S. CORR.) 106, pressure correction block (P. CORR.) 108, speed calculator block 110, pressure calculator block 112, speed control proportional integral algorithm (S.C. P. I.) 114, and pressure control proportional integral algorithm (P.C.P.I.) 116.

Within APU controller 24, baseline speed schedule 102 produces speed setpoint SPT_{S}, and baseline pressure schedule 104 produces pressure setpoint SPT_{P}. These setpoints correspond to desired engine speed and pressure, respectively, for a fixed value of bleed airflow demand. Baseline speed and pressure schedules 102 and 104 receive inputs including compressor inlet temperature signal T_{CI} and compressor inlet pressure signal P_{CI}, and determine speed setpoint SPT_{S} and pressure setpoint SPT_{P} by means of algorithms or lookup tables. Compressor inlet temperature and pressure are, for instance, either algorithm parameters or dimensions of lookup tables.

APU controller 24 receives airflow demand signal AD, as previously noted, from air management system controller 28. Speed correction block 106 calculates speed correction factor SCF arithmetically from airflow demand signal AD, compressor inlet temperature signal T_{CI}, and compressor inlet pressure signal P_{CI}. Pressure correction block 108 calculates pressure correction factor PCF arithmetically from airflow demand signal AD, compressor inlet temperature signal T_{CI}, and compressor inlet pressure signal P_{CI}. Speed correction factor SCF and pressure correction factor PCF are used to scale speed setpoint SPT_{S} and pressure setpoint SPT_{P} at speed calculator block 110 and pressure calculator block 112, respectively. Speed calculator block 110 multiplies speed setpoint SPT_{S} by speed correction factor SCF to produce factored speed setpoint FSPT_{S}, which reflects the desired engine speed corrected to account for the airflow demand from air management system controller 28. Factored speed setpoint FSPT_{S} reflects the desired engine speed for a given airflow demand signal AD. Similarly, pressure calculator block 112 multiplies pressure setpoint SPT_{P} by pressure correction factor PCF to produce factored pressure setpoint FSPT_{P}, which reflects the desired engine pressure for a given airflow demand signal AD.

In an illustrative embodiment, baseline speed schedule 102 produces a speed setpoint SPT_{S} corresponding to optimal engine speed if 100% of maximum bleed air were requested by air management system controller 28. In this example, if airflow demand signal AD indicated that air management system 26 needed only 50% of maximum bleed air, speed correction block 106 would produce a scaling value less than one as speed correction factor SCF, reflecting the fact that a lower engine speed would be adequate to supply all of the required bleed air (and that fueling a higher engine speed would therefore be wasteful). Speed setpoint SPT_{S} would then be reduced according to speed correction factor SCF to provide a factored speed setpoint FSPT_{S} corresponding to an engine speed that would enable sufficient bleed to satisfy the demands of air management system 26 with minimum fuel expenditure.

Factored speed setpoint FSPT_{S} and factored pressure setpoint FSPT_{P} are used by proportional integral feedback algorithms to continuously regulate the rate of fuel flow into combustor 14 and the position of inlet guide vanes in load compressor 18, respectively. Speed control proportional integral algorithm 114 combines the weighted integral and weighted sum of the difference between factored speed setpoint FSPT_{S} and engine rotational speed signal S_{ER} to produce fuel flow rate command FR. This regulation results in a feedback loop: engine rotational speed will vary as more or less fuel is fed into combustor 14 in accordance with fuel flow rate command FR, and this rotational speed change will be reflected by a change in engine rotational speed signal S_{ER}. Thus, speed control proportional integral algorithm 114 constitutes a feedback algorithm which will continuously adjust the fuel supply rate to combustor 14 so as to reduce the difference between the factored speed setpoint and the actual engine speed.

Pressure control proportional integral algorithm 116 operates analogously to speed control proportional algorithm 114. Factored pressure setpoint FSPT_{P} is combined with compressor exit pressure signal P_{EXIT} to produce inlet guide vane control command IGVP, which represents a correction to inlet guide vane position. This feedback loop will continuously adjust inlet guide vane position until desired pressure is achieved.

Exhaust gas temperature signal T_{EG} operates as a limit on the normal functioning of the aforementioned system. Extremely high temperatures can be harmful to the continued functioning and long-term durability to the APU. To prevent damage, APU controller 24 computes a ceiling to fuel flow rate command FR and restricts inlet guide vane position command IGVP, based on exhaust gas temperature T_{EG}, so as to prevent overheating.

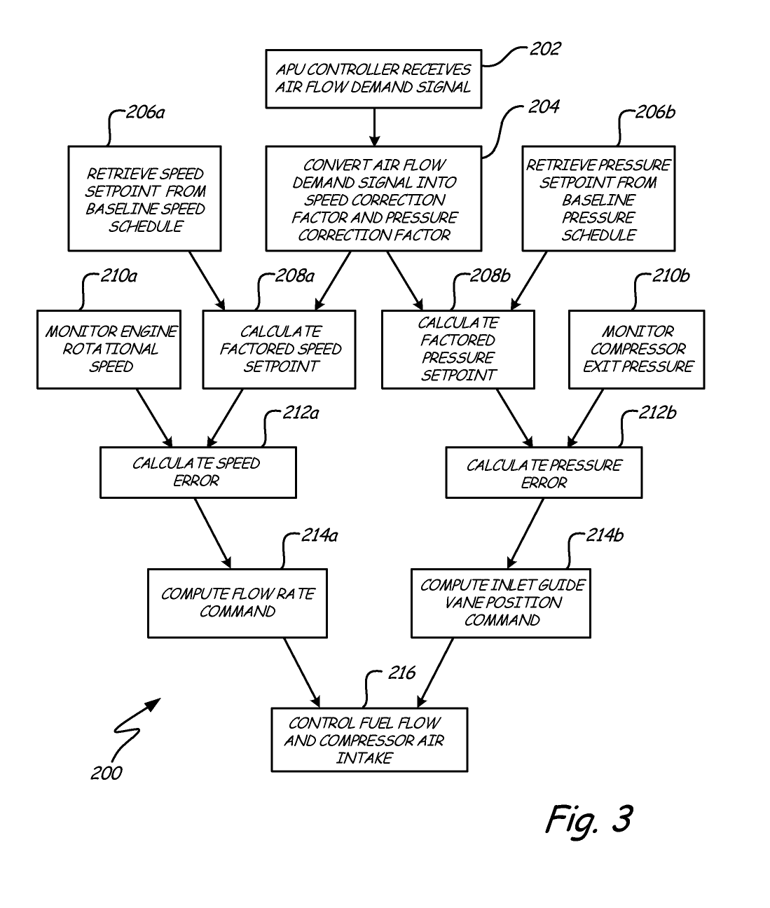

FIG. 3 is a flow diagram illustrating the steps of a method for controlling APU 10 according to inputs from air management system controller 28. This method generally restates the process described above. First, APU controller 24 receives airflow demand signal AD from air management system controller 28 (Step 202). This airflow demand signal is then converted into speed correction factor SCF and pressure correction factor PCF by speed correction block 106 and pressure correction block 108, respectively (Step 204). Baseline speed schedule 102 next retrieves speed setpoint SPT_{S} (Step 206a), and baseline pressure schedule 104 retrieves pressure setpoint SPT_{P} (Step 206b). Speed setpoint SPT_{S} is multiplied by speed correction factor SCF to produce factored speed setpoint FSPT_{S} (Step 208a), and pressure setpoint SPT_{P} is multiplied by pressure correction factor PCF to produce factored pressure setpoint FSPT_{P} (Step 208b).

Speed control proportional integral algorithm 114 continuously monitors engine rotational speed via engine rotational speed signal S_{ER} (Step 210a). Pressure control proportional integral algorithm 116 continuously monitors pressure at the exit of load compressor 18 via compressor inlet vane position signal P_{EXIT} (Step 210b). In order to regulate engine operation, speed control proportional integral algorithm 114 then takes the difference between factored speed setpoint FSPT_{S} and engine rotational speed signal S_{ER} to produce a speed error value (Step 212a). The weighted sum and integral over time of this speed error value are combined to produce fuel flow rate command FR (Step 214a). Similarly, pressure control proportional integral algorithm 116 takes the difference between factored pressure setpoint FSPT_{P} and compressor inlet guide vane position signal P_{EXIT} to produce a pressure error value (Step 212b). The weighted sum and integral over time of this pressure error value are combined to produce compressor inlet guide vane position command IGVP (Step 214b).

Finally, fuel flow rate command FR is transmitted to fuel system 20 to control fuel flow, and inlet guide vane position command IGVP is transmitted to load compressor 18 to control air intake (Step 216). Rotational speed, airflow, and pressure in APU 10 will vary in response to these signals, giving rise through a feedback loop to continuous changes in fuel flow rate command FR and inlet guide vane position command IGVP, thereby continuously zeroing in on desired engine operation conditions.

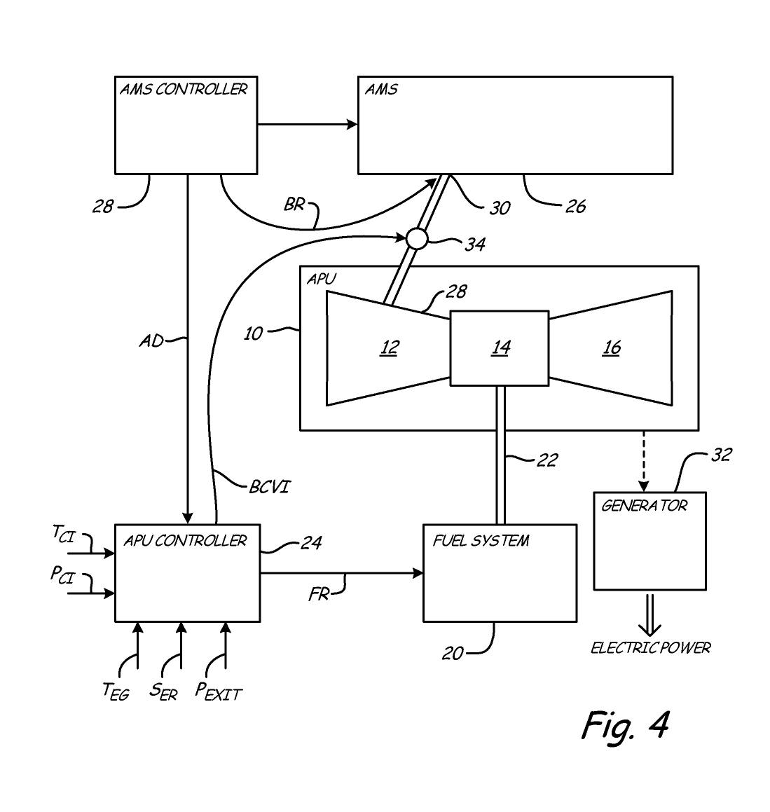

FIG. 4 is a diagram of an alternative embodiment of the system depicted in FIG. 1, including auxiliary power unit (APU) 10 (including primary compressor 12, combustor 14, turbine 16), fuel system 20 with fuel line 22, APU controller 24, air management system 26, air management system controller 28, siphon 30, generator 32, and variable bleed valve 34. In this embodiment APU 10 does not include a separate load compressor 18; instead, air for air management system 26 is bled off of primary compressor 12. The rate of this air bleed is controlled by variable bleed valve 34, which bleeds more or less air off of primary compressor 12 as commanded by air management controller 28 via bleed regulation signal BR, which is the equivalent of siphon regulation signal SR in FIG. 1. In this embodiment, APU controller 24 does not regulate the position of inlet guide vanes of the controller, but rather regulates the bleed rate of variable bleed valve 34 via bleed control valve current BCVI. The position of variable bleed valve 34 is proportional to bleed control valve current BCVI. Accordingly, pressure control proportional integral algorithm 116 produces bleed control valve current BCVI in this embodiment, rather than an inlet guide vane position signal.

In the past, air management systems have controlled the rate of air bleed from a turbine compressor, but have not been involved in the control of engine operation parameters such as engine fuel and air intake. By controlling fuel and air flow into APU 10 in accordance with airflow demand AD, the present invention is able to minimize waste air compression without interfering with electrical power generation. This improves the average fuel efficiency of APU 10.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A system comprising:
a gas turbine engine;
an air management system for regulating cabin pressure and temperature and connected to receive bleed air from the gas turbine engine; and
a turbine controller for controlling operation of the gas turbine engine according to an airflow demand signal indicative of air flow required by the air management system.

2. The system of claim 1, wherein the turbine controller controls at least one of fuel flow into the gas turbine engine or air intake of a compressor of the gas turbine engine according to the airflow demand signal.

3. The system of claim 2, wherein the gas turbine engine includes a first compressor providing compressed air to a combustor, and a second compressor for supplying compressed air to the air management system.

4. The system of claim 3, wherein the turbine controller controls air intake of the second compressor of the gas turbine engine via a compressor air flow command, and controls fuel flow into the gas turbine engine via a fuel flow rate command.

5. The system of claim 2, wherein the turbine controller controls bleed rate of air bled off of a compressor of the gas turbine engine via a bleed rate signal, and controls fuel flow into the gas turbine engine via a fuel flow rate command.

6. The system of claim 2, wherein the turbine controller comprises:
a speed correction block for converting an airflow demand signal into a speed correction factor;
a pressure correction block for converting the airflow demand signal into a pressure correction factor;
a baseline speed schedule for producing a speed setpoint;
a baseline pressure schedule for producing a pressure setpoint;
a speed calculator block for calculating a factored speed setpoint from the speed correction factor and the speed setpoint;
a pressure calculator block for calculating a factored pressure setpoint from the pressure correction factor and the pressure setpoint;
an engine speed input for receiving an engine speed signal reflecting the rotational speed of the gas turbine engine;
a compressor exit temperature input for receiving a compressor exit pressure signal reflecting the pressure of gas as it leaves a compressor of the gas turbine engine;
a first feedback algorithm for computing the fuel flow rate command from the engine speed signal and the factored speed setpoint; and
a second feedback algorithm for computing a compressor air flow command from the inlet guide vane position signal and the factored pressure setpoint, the air flow command comprising either a compressor inlet guide vane position command, or a compressor bleed control valve command.

7. The system of claim 6, wherein the first and second feedback algorithms are proportional integral algorithms, and:
the fuel flow rate command is produced by combining a weighted integral and a weighted sum of a difference between the engine speed signal and the factored speed setpoint; and
the compressor air flow command is produced by combining a weighted integral and a weighted sum of a difference between the compressor exit pressure signal and the factored pressure setpoint.

8. The system of claim 1, wherein the turbine controller controls at least one parameter of the gas turbine engine as a function of the airflow demand signal and at least one of compressor inlet temperature, compressor inlet pressure, exhaust gas temperature, and compressor exit pressure.

9. A turbine controller for controlling at least one operational parameter of a gas turbine engine based at least in part on an airflow demand signal indicating required airflow for an air management system for regulating cabin pressure and temperature.

10. The turbine controller of claim 9, wherein the turbine controller controls fuel flow rate into the gas turbine engine as a function of the airflow demand signal.

11. The turbine controller of claim 9, wherein the turbine controller controls inlet guide vane position in the compressor of the gas turbine engine as a function of the airflow demand signal.

12. The turbine controller of claim 9, wherein the turbine controller controls fuel flow rate into the gas turbine engine and inlet guide vane position in a compressor of the gas turbine engine as a function of the airflow demand signal.

13. The turbine controller of claim 12, wherein the turbine controller comprises:
a speed correction block for converting the airflow demand signal into a speed correction factor;
a pressure correction block for converting the airflow demand signal into a pressure correction factor;
a baseline speed schedule for producing a speed setpoint;
a baseline pressure schedule for producing a pressure setpoint;
a speed calculator block for calculating a factored speed setpoint from the speed correction factor and the speed setpoint;
a pressure calculator block for calculating a factored pressure setpoint from the pressure correction factor and the pressure setpoint;
an engine speed input for receiving an engine speed signal reflecting the rotational speed of the gas turbine engine;
a compressor exit pressure input for receiving a compressor exit pressure signal reflecting the pressure of gas as it leaves a compressor of the gas turbine engine;
a first feedback algorithm for computing the fuel flow rate command from the engine speed signal and the factored speed setpoint; and
a second feedback algorithm for computing the compressor inlet guide vane position command from the inlet guide vane position signal and the factored pressure setpoint.

14. The turbine controller of claim 13, wherein the first feedback algorithm and the second feedback algorithm are proportional integral algorithms.

15. The turbine controller of claim 9, wherein the turbine controller also controls the at least one operational parameter of the gas turbine engine as a function of least one of engine inlet temperature, engine inlet pressure, and engine exhaust gas temperature, and compressor exit pressure.

16. A method for controlling an auxiliary power unit, the method comprising:
receiving an airflow demand signal indicative of air flow required by an air management system;
producing at least one command signal from the airflow demand signal via a feedback process; and
controlling the auxiliary power unit with the at least one command signal.

17. The method of claim 16, wherein the at least one command signal is a fuel flow rate command, and producing at least one command signal comprises:
receiving a turbine rotational speed signal;
converting the airflow demand signal into a speed correction factor;
retrieving a speed setpoint from a baseline speed schedule;
calculating a speed error value by taking the difference between the turbine rotational speed signal and the product of the speed correction factor and the speed setpoint; and
continuously generating the fuel flow rate command from the speed error value in a feedback loop.

18. The method of claim 16, wherein the at least one command signal is a compressor inlet guide vane position command, and producing at least one command signal comprises:
receiving a compressor exit pressure signal;
converting the airflow demand signal into a pressure correction factor;
retrieving a pressure setpoint from a baseline pressure schedule;
calculating a pressure error value by taking the difference between the compressor exit pressure signal and the product of the pressure correction factor and the pressure setpoint; and
continuously generating the compressor inlet guide vane position command from the pressure error value in a feedback loop.

19. The method of claim 16, wherein the at least one command signal command signal comprises a fuel flow rate command and a compressor inlet guide vane position command, and producing at least one command signal comprises:
receiving a turbine rotational speed signal and a compressor exit pressure signal;
converting the airflow demand signal into a speed correction factor and a pressure correction factor;
retrieving a speed setpoint from a baseline speed schedule and a pressure setpoint from a baseline pressure schedule;
calculating a speed error value by taking the difference between the turbine rotational speed signal and the product of the speed correction factor and the speed setpoint;
calculating a pressure error by taking the difference between the compressor exit pressure signal and the product of the pressure correction factor and the pressure setpoint;
generating the fuel flow rate command from the speed error value in a first feedback loop; and
generating the compressor inlet guide vane position command from the pressure value in a second feedback loop.

20. The method of claim 19, wherein the first feedback loop and the second feedback loop are proportional integral algorithms.
